(19) United States
(12) Patent Application Publication
(10) Pub. No.: US 2004/0178054 A1
(43) Pub. Date: Sep. 16, 2004

(54) Bayliss ranch extraction process

(76) Inventors: Donna Bayliss Wallace, Biggs, CA (US); Stan Loft, San Diego, CA (US)

Correspondence Address: Renee S. Rutkowski, Low and Low, 2316 S. Eads Street, Arlington, VA, 22202, US

(21) Appl. No.: 10/383,882

(22) Filed: Mar. 10, 2003

(51) Int. Cl. B01D 3/38

(52) U.S. Cl. 203/85

(57) ABSTRACT

The present invention, known as The Bayliss Ranch Extraction Process, was developed for the production of hydrosols from botanical materials and involves extracting hydrosol by steam distillation. The two-stage process may be used with various botanical materials, including flowers, herbs, fruits, nuts, grasses, grains and vegetables. The process produces high quality hydrosol that can then be utilized by the consumer without further treatment, or used as a raw material in the manufacture of other products such as food, medicines and cosmetics.

### TECHNICAL FIELD OF THE INVENTION

The present invention, The Bayliss Ranch Extraction Process, for producing hydrosol involves extraction of hydrosol from plant material using water, in the form of steam. The process produces hydrosol that is free of solvent residue, and which therefore may be certified as organic. The two-stage process allows for fast and efficient extraction and recovery of hydrosol resulting in maximum yield of hydrosols per batch of plant material processed.

### BACKGROUND OF THE INVENTION

Essential oils are volatile oils obtained from flowers, buds, leaves, branches, stems, roots, etc. of various plants. The essential oils have aromas characteristic of the plants from which they are obtained and may be utilized as raw materials for perfumes, cosmetics, household products, aromatherapy products, medicinal products, and pharmaceuticals. Essential oils have been obtained by methods such as steam distillation, extraction and expression.

Hydrosols, as defined in McGraw-Hill Dictionary of Scientific and Technical Terms (www.accesscience.com) are colloidal systems in which the dispersion medium is water and the dispersed phase may be a solid, a gas, or another liquid; also known as aquasols.

### SUMMARY OF THE INVENTION

The present invention, The Bayliss Ranch Extraction Process, provides a method for producing high quality essential oils and hydrosol. The mixture of hydrosol and volatile organic oils are in constant eqilibrium; no other solvent is used to maintain the equilibrium. The simple, fast, and efficient process results in a significant increase in yield over methods currently being used in the industry. For maximum yield, a multiple batch process may be used. The Bayliss Ranch Extraction Process is versatile and ruggedly designed such that it may be applied to other botanical materials without further modification.

### BRIEF DESCRIPTION OF THE DRAWINGS

FIG. 1 is a block diagram of step one of the inventive process.

FIG. 2 is a block diagram of step two of the inventive process.

FIG. 3 is a block diagram of the filling step of the inventive process.

FIG. 4 is a block diagram of the inventive process, as a stand-alone process.

### DETAILED DESCRIPTION OF THE PREFERRED EMBODIMENT

The present invention will be set forth as it applies to its preferred embodiment, that is as part of a multiple-step batch process. The Bayliss Ranch Extraction Process may be used as a single batch or multiple batch process. It is not intended that the present invention be limited to the described embodiment. It is intended that the invention cover all alternatives, modifications, and equivalencies which may be included within the spirit and scope of the invention.

### Manufacturing Process

A) Production of Hydrosol

1) Stage One—Preparation of 1^{st} Run Hydrosol

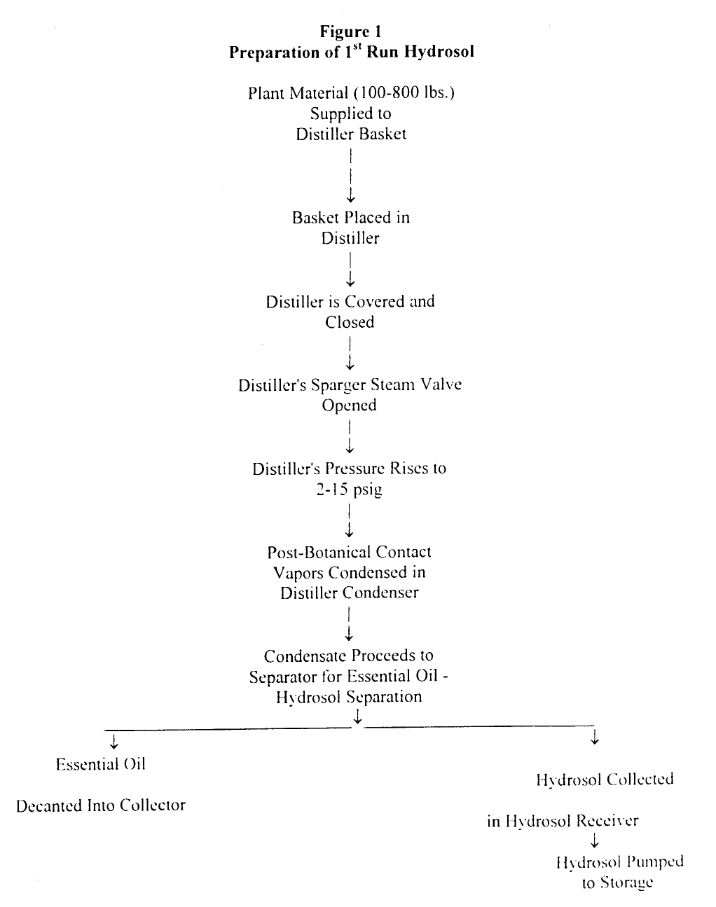

In the preparation of the initial product, 1^{st} Run hydrosol (FIG. 1), 100-800 pounds of lavender or other plant material is transferred to the distillation facility in a removable basket. The basket is placed into a clean, stainless steel distillation tank, T-100. The tank is covered, and is bolted closed.

The distillation tank is connected to a condenser, E-102, by a suitable connector. The entire process is computer controlled and the specified temperature and pressure is set using the process control panel. The steam inlet valve is opened and live steam enters the distillation tank. Steam distillation is allowed to proceed for approximately 30 to 90 minutes, depending on the type of plant material used. The distillate, consisting of hydrosol (1^{st} Run) and essential oils, is collected and the essential oils are separated, labeled and stored. The separated hydrosol is collected in a receiving tank (T-104), sparged with pure nitrogen, filtered using a 1.0 micron filter (F-105), and stored in nitrogen blanketed tanks (T-106, 107, 108 & 109) for further processing.

At the end of the distillation period, the length depending on the type of flora being distilled, the distilling equipment is secured. The condenser is drained to remove any residual condensate; the tank is opened and the basket of spent material is removed.

2) Stage Two—Preparation of final product, 2^{nd} Run Hydrosol

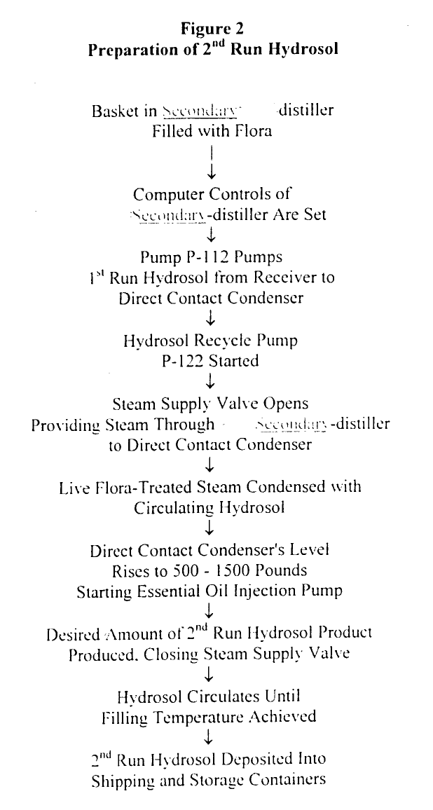

In the preparation of the final product, called 2^{nd} Run Hydrosol (FIG. 2), baskets in the distiller (T-111) are filled with flora or other materials. The entire process is computer controlled and operating conditions for the distiller pre-set for the amount of hydrosol to be produced.

A specified amount of 1^{st} Run Hydrosol is pumped (P-112) into and recirculated (P-122) in the specially designed condenser, called, the Direct Contact Condenser. The steam supply valve (COV-111) opens allowing steam to flow through the distiller containing the flora material. The steam, rich in hydrosol and essential oils, condenses with the circulating hydrosol in the Direct Contact Condenser. When approximately 500 to 1,500 pounds of product has been distilled, a specified amount of 1^{st} Run Hydrosol containing trace amounts of the original essential is injected (P-123) into the steam, producing oil 2^{nd} Run hydrosol. The steam supply valve COV-111 automatically shuts the supply of steam to the system when the preset amount of 2^{nd} Run Hydrosol has been achieved.

The 2^{nd} Run hydrosol will continue to circulate through the Direct Contact Condenser until the desired tote filling temperature is achieved. At this point in the process, the batch is complete and ready for filling.

B) Filling and Finishing

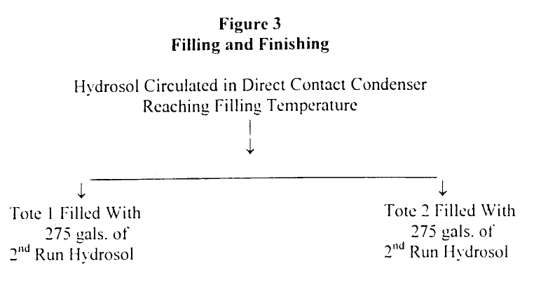

In the filling and finishing process (FIG. 3), two containers, or totes, each able to hold 275 gallons, are placed are placed in position at the filling station, with two flex hoses and fill nozzles places in each tote. A selector switch in “auto” permits the filling of totes 1 and 2 in sequence. The filled totes are labeled and stored for shipment.

### Further Discussion of the Invention

In the first step of the inventive process, the steam distillation conventionally starts with 100-800 pounds of fresh or green flora, such as lavender. The process, as described, produces approximately 74 gallons of hydrosol, and 0.5 to 1.0 gallon of essential oil. Products of the first stage are then recirculated in the Direct Contact Condenser. In a full batch process, where two 275 gallon totes are filled with final product of 2^{nd} Run hydrosol, approximately 1.0-15.0 gallons of 1^{st} Run hydrosol containing 1.0-10.0 ounces of essential oil is injected into the Direct Contact Condenser, producing 550 gallons of final product.

The final hydrosol product can be stored in drums or totes, and may be used by consumers directly without further treatment, dilution, or purification. The 2^{nd} Run hydrosol product may be utilized as an ingredient in the manufacture of a large number of products.

It is important to note that the amounts of flora, hydrosol, essential oil, and water as steam, etc., may vary, based on the quality and oil content of the starting flora. In addition, the figures presented are for the use of lavender as the floral material. Other botanical materials can be used yielding similar essential oil and hydrosol production results. Illustratively, and not exclusively, botanicals, which may be used for the disclosed process include lavender, rosemary, clary sage, lemon verbena, lemon balm or sweet melissa, chocolate mint, and rose geranium. In addition, the process can be applied to a wide variety of agricultural products including, but not limited to, fruits, vegetables, nuts, grasses and grains.

The inventive process may be conducted, as set forth above as part of a two-stage batch process, the first stage being a modified simple steam distillation of botanical material wherein some of the essential oil is extracted. Alternatively, the process may be started at the second stage of the operation, in which the 1^{st} Run hydrosol is supplied from storage or shipping tanks, and distilled with the 2^{nd} Run hydrosol (FIG. 2). By using this method of production, 1^{st} Run hydrosol can be produced at the convenience of the manufacturer, with the 2^{nd} Run hydrosol and produced at a later time. This method provides flexibility for the manufacturer, so that the process may be conducted dependent on availability of botanical product, manpower, warehouse storage, market need, and the like.

The process set forth in the application permits production of a greater yield of hydrosol from botanical material than known conventional processes, which employ a single steam distillation step, or extraction of oils using solvents which leave a residue and are therefor unacceptable in many industries.

The higher yield of hydrosol in the inventive Bayliss Extraction Process is an advance step in making natural botanical products available in an easy and economical process. The process makes such botanicals more readily available in the marketplace, providing a benefit to consumers on all levels. Botanical hydrosols are used as ingredients in a wide range of industries, including but not exclusively, those producing personal care products, aromatherapy products, cosmetics, hair care products, skin care products, household cleaning products, household environmental fresheners, laundry products, clothing and fibre treatment, pet care products, gardening products, and pest control products. A wide range of products are covered such as body lotions, deodorants, face packs, toners, scrubs, wipes, bath and body soaps, cleansers, spritzes, mists, remedies for burns and wounds, makeup, hair coloring, hair shampoos and conditioners, hair coloring, nail polishes, polish removers, makeup removers, perfumes, toothpastes, mouthwashes, shaving creams, after-shaves, styling gels, sunscreens, lip balms and the like. Botanical hydrosols also may be used as food ingredients in such products as soups, salad dressings, marinades, sauces, food supplements, flavorings for beverages and liquors, and in therapeutic remedies such as those for respiratory, digestive, circulatory, reproductive, muscular and nervous system problems, and vitamin and dietary supplements. Thus, the process for making such products accessible and economically recoverable provides a huge benefit to the consumer and to the marketplace.

The preferred embodiment of the present Extraction Process has been set forth in the drawings and specification and although specific terms are employed, these are used in a generic and descriptive sense only and are not used for the purpose of limitation. Changes in the form and proportion of parts as well as in the substitution of equivalents are contemplated as circumstances may suggest or render expedient without departing from the spirit and scope of the invention as further defined in the following claims.

What is claimed:

1. A two-stage process for the production of hydrosol and essential oil from botanical material comprising the steps of:
Beginning the first stage by providing an amount of plant material to a distiller;
Supplying live steam to the distiller;
Condensing the volatile constituents-containing vapors;
Removing the 1^{st} Run Hydrosol and reintroducing it into the direct contact condenser;
Removal of the distilled essential oil which is reintroduced into the hydrosol by means of injection into the direct contact condenser.

2. A two-stage process for the production of hydrosol and essential oil from botanical material comprising: the steps of
beginning the first stage by providing an amount of plant material to a distiller;
Supplying live steam to the distiller;
Condensing the volatile constituents-containing vapors;
Separating the distilled oil from the hydrosol;
Beginning the second stage by filling a distiller with botanical material;
Filling the direct contact condenser with hydrosol;
Passing live steam through the minidistiller into the direct contact condenser;
Injecting essential oil into the direct contact condenser;
Closing the supply of steam;
Continuing to circulate hydrosol through the direct contact condenser until a desired temperature is achieved;
Removing hydrosol from direct contact condenser.

3. A method for the production of hydrosol from botanical material by
Filling the direct contact condenser with 1^{st} Run hydrosol;
Passing live steam through the distiller into the direct contact condenser;
Injecting essential oil into the direct contact condenser;
Closing the supply of steam;
Continuing to circulate hydrosol through the direct contact condenser until a desired temperature is achieved;
Removing the 2^{nd} Run hydrosol from direct contact condenser.
